(19) United States
(12) Patent Application Publication
(10) Pub. No.: US 2012/0128885 A1
(43) Pub. Date: May 24, 2012

(54) CORROSION-RESISTANT MULTILAYER VARNISH AND METHOD FOR THE PRODUCTION THEREOF

(75) Inventor: Michael Dornbusch, Ludenscheid (DE)

(73) Assignee: BASF COATINGS GMBH, Muenster (DE)

(21) Appl. No.: 13/146,026

(22) PCT Filed: Dec. 24, 2009
(86) PCT No.: PCT/EP2009/009270

§ 371 Date: Sep. 13, 2011

(30) Foreign Application Priority Data
Feb. 5, 2009 (DE) 10 2009 007 633.6

(51) Int. Cl. B05D 5/00; B05D 7/14; B05D 1/36

(52) U.S. Cl. 427/402

(57) ABSTRACT

An electroless deposition coating is applied in a first stage with an aqueous corrosion preventative (K1), comprising at least one compound (A1) having a lanthanide metal cation and/or a d-element metal cation and/or a d-element metallate as anion, and at least one acid (A2) capable of oxidation; a further electroless deposition coating is applied in a second stage with an aqueous corrosion preventative (K2) which comprises at least one preferably water-dispersible and/or water-soluble polymer (P) having covalently bonded ligands (L) which form chelates with the metal ions released on corrosion of the substrate, and/or with the substrate surface, and having functional groups (B), and at least one water-dispersible and/or water-soluble crosslinker (V) having functional groups (B′) which react with the functional groups (B) of the polymer, and having covalently bonded ligands (L′) which form chelates with the metal ions released on corrosion of the substrate, and/or with the substrate surface.

Processes and coating compositions for electroless corrosion control coating of various metal substrates as a pretreatment for an automotive OEM finish, particularly by means of autophoretic deposition coating, are known. They offer the advantage of a simpler and more cost-effective operation and also of a shorter operating time. In particular it is possible with the electroless processes to coat cavities in or edges on the substrates to be coated more effectively than with processes which necessitate the application of electrical voltages.

More recently an aim has been to develop chromium-free autophoretic coating compositions which ensure very good corrosion control, comparable with that afforded by chromium-containing coating compositions. In this context, coating compositions comprising salts of the lanthanide elements and also of the d-elements, and also an organic film-forming component, have proven particularly suitable. The autophoretic coating compositions described, for example, in WO-A-99/29927, WO-A-96/10461 and DE-A-37 27 382, however, have disadvantages including the tendency of the metal ions formed from the substrate to migrate through the deposited corrosion control coat, and also the use of environmentally critical substances, such as fluorides in particular.

DE-A-10 2005 023 728 and DE-A-10 2005 023 729 describe coating compositions which are an excellent solution to the problem of the tendency of the metal ions formed from the substrate to migrate through the deposited corrosion control coat and also to the problem of the use of environmentally critical substances. The two-stage process for imparting corrosion control to metallic substrates that is described in DE-A-1 0 2005 023 728, in particular, in which in a first stage the substrate is immersed into a bath of a corrosion preventative K which brings about conversion on the substrate surface, and, in a second stage, the substrate treated in stage (a) is immersed into a bath of an aqueous coating composition comprising a water-dispersible and/or water-soluble polymer P with covalently bonded ligands which form chelates with the metal ions released on corrosion of the substrate, and/or with the substrate surface, and also with crosslinking functional groups B which are able to form covalent bonds with themselves, with further, complementary functional groups B′ of the polymer P and/or with further functional groups B and/or B′ on crosslinkers V, has proven particularly appropriate.

WO-A-2008/110195 describes the combination of a 2-stage pretreatment of metal substrates, in accordance with DE-A-10 2005 023 728 and DE-A-10 2005 023 729, with a subsequent electrodeposition coating operation. The coating thus produced combines effective corrosion control with a high environmental compatibility. Although the pretreatment according to WO-A-2008/110195 constitutes a large step forward in simplifying the pretreatment of metal substrates which, subsequently, in the context of automotive OEM finishing, are provided with an electrodeposition coat, with a primer-surfacer, and also with a basecoat and, in conclusion, with a clearcoat, there continues to be a need to simplify the overall operation of automotive OEM finishing, particularly with regard to the number of operating steps and/or of coating steps. A matter of great interest in automotive OEM finishing is the replacement of the costly and inconvenient electrodeposition coat.

### THE PROBLEM ADDRESSED BY THE INVENTION

In the light of the above prior art it was an object of the invention to find a largely environmentally unobjectionable process for imparting corrosion control, particularly in the automobile segment, which can be applied to the substrate to be protected by means of an operation which is easy to carry out from a technical standpoint. The process ought more particularly to contribute to simplifying the overall operation associated with automotive OEM finishing, especially in respect of the simplification and combination of individual operating steps, a particular aim being to replace the electrodeposition coating step, as a particularly costly and inconvenient operating step. An aim more particularly was to achieve effective adhesion between the corrosion control finish and the subsequent coats of the automotive OEM finish, and, in particular, effective adhesion between the corrosion control coat and the primer-surfacer coat.

Moreover, the process of the invention ought in particular to lead to a corrosion control finish in automotive OEM finishing in which the migration of the metal ions formed from the substrate is largely prevented, and which is highly effective at edges and in cavities of the substrate. Furthermore, the intention was that the influence of extraneous metal ions should be minimized and that effective corrosion control should be obtained with comparatively little deployment of material.

### THE SOLUTION PROVIDED BY THE INVENTION

In the light of the above objects, a process has been found for imparting corrosion control to unpretreated metallic substrates, in combination with an automotive OEM finish, that permits a substantial reduction in the number of operating steps, comprising, as it does, the following stages:
(I) in a first stage, an electroless deposition coating with an aqueous corrosion preventative (K1), comprising at least one compound (A1) having a lanthanide metal cation and/or a d-element metal cation and/or a d-element metallate as anion, and (A2) at least one acid capable of oxidation,
(II) in a second stage, a further electroless deposition coating with an aqueous corrosion preventative (K2) which comprises a preferably water-dispersible and/or water-soluble polymer (P) having covalently bonded ligands (L) which form chelates with the metal ions released on corrosion of the substrate, and/or with the substrate surface, and also having functional groups (B), which are able to form covalent bonds with themselves, with further functional groups (B′) of the polymer P and/or with further functional groups (B) and or (B′) on crosslinkers V,
(III) in a third stage, a further coating by means of the application of a preferably aqueous coating composition (F) comprising at least one binder (FB) having the above-described functional groups (B) and/or (B′), and also
(IV) in a concluding stage, the application of a topcoat, preferably composed of a first basecoat and a concluding clearcoat.

### DESCRIPTION OF THE INVENTION

### The First Stage (I) of the Process of the Invention

In the first stage (I) of the process of the invention the aqueous corrosion preventative (K1) described below is applied electrolessly to the metallic substrate. Electrolessly here signifies the absence of electrical currents through application of an electrical voltage. The substrate is preferably cleaned before the aqueous corrosion preventative (K1) is applied, and more particularly is cleaned to remove oily and greasy residues, using preferably detergents and/or alkaline cleaners. In a further preferred embodiment of the invention the cleaning with detergents and/or alkaline cleaners is followed, before the coating composition of the invention is applied, by a further rinse with water. In order to remove deposits and/or chemically modified, especially oxidized, layers on the surface of the substrate it is possible, in a further preferred embodiment of the invention, for the rinsing step to be preceded by mechanical cleaning of the surface, with abrasive media, for example, and/or by chemical removal of the surface layers, using deoxidizing cleaners, for example.

The aqueous corrosion preventative (K1) has a pH of between 1 and 5 and comprises at least one compound (A1) having a lanthanide metal cation and/or a d-element metal cation, preferably with the exception of chromium as the cation, and/or having a d-element metallate, preferably with the exception of chromium-containing metallates, as anion, and also (A2) at least one acid capable of oxidation, preferably with the exception of phosphorus acids and/or chromium acids. The avoidance of chromium and phosphorus components in the corrosion preventative (K1) is preferred on environmental grounds.

The compound (A1) is highly soluble in water. Particular preference is given to compounds (A1) [cation]n[anion]m (with n,m>=1) having a solubility product SP=[cation]ⁿ*[anion]^{m}>10⁻⁸*mol^{(n+m)}/l^{(n+m)}, very preferably compounds (a1) having a solubility product SP>10⁻⁶*mol^{(n+m)}/l^{(n+m)}. In one particularly preferred embodiment of the invention the concentration of the compounds (A1) in the corrosion preventative (K1) is 10⁻¹ to 10⁻⁴ mol/l, more particularly 5*10⁻¹ to 10⁻³ mol/l.

As a cationic constituent the compound (A1) comprises lanthanide metal cations and/or d-element metal cations. Preferred lanthanide metal cations are lanthanum, cerium, praseodymium, neodymium, promethium, samarium, europium and/or dysprosium cations. Very particular preference is given to lanthanum, cerium, and praseodymium cations. The lanthanide metal cations may be present in a monovalent, divalent and/or trivalent oxidation state, the trivalent oxidation state being preferred. Preferred d-element metal cations are titanium, vanadium, manganese, yttrium, zirconium, niobium, molybdenum, tungsten, cobalt, ruthenium, rhodium, palladium, osmium and/or iridium cations. Preferably excepted as a d-element metal cation is the chromium cation in all oxidation states, on account of its environmentally critical properties. Very particular preference is given to vanadium, manganese, tungsten, molybdenum and/or yttrium cations. The d-element metal cations may be present in a monovalent to hexavalent oxidation state, preference being given to a trivalent to hexavalent oxidation state.

The anions that form the compounds (A1) with the lanthanide metal cations and/or d-element metal cations are preferably selected such that the aforementioned conditions for the solubility product SP are met. Preference is given to anions of oxidizing acids of elements from transition groups VI, VII, and VIII of the Periodic Table of the Elements, and also to anions of oxidizing acids of the elements from main groups V and VI of the Periodic Table of the Elements, preferably with the exception of anions of oxidizing acids of phosphorus and chromium, on account of their environmentally critical properties, such as, preferably, nitrates, nitrites, sulfites and/or sulfates. Also possible as anions are halides bar fluorides.

In a further embodiment of the invention the lanthanide metal cations and/or d-element metal cations of the compounds (A1) may also take the form of complexes with unidentate and/or multidentate, potentially anionic ligands (L1). Preferred ligands (L1) are optionally functionalized terpyridines, optionally functionalized ureas and/or thioureas, optionally functionalized amines and/or polyamines, such as, in particular, EDTA, imines, such as, in particular, imine-functionalized pyridines, organosulfur compounds, such as, in particular, optionally functionalized thiols, thiocarboxylic acids, thioaldehydes, thioketones, dithiocarbamates, sulfonamides, thioamides, and, with particular preference, sulfonates, optionally functionalized organoboron compounds, such as, in particular, boric esters, optionally functionalized polyalcohols, such as, in particular, carbohydrates and their derivatives, and also chitosans, optionally functionalized acids, such as, in particular, difunctional and/or oligofunctional acids, optionally functionalized carbenes, acetylacetonates, optionally functionalized acetylenes, optionally functionalized carboxylic acids, such as, in particular, carboxylic acids which can be bonded ionically and/or coordinatively to metal centers, and also phytic acid and derivatives thereof.

In one particularly preferred embodiment of the invention the compounds (A1) comprise d-element metallates as anions, which are able to form, either together with the d-element metal cations or else on their own, the compound (A1). Preferred d-elements for the metallates are vanadium, manganese, zirconium, niobium, molybdenum and/or tungsten. Preferably excepted as d-element metallates are chromates in all oxidation states, on account of their environmentally critical properties. Particularly preferred d-element metallates are oxo anions, such as, in particular, tungstates, permanganates, vanadates and/or, with very particular preference, molybdates.

Where the d-element metallates form the compound (A1) by themselves, in other words without lanthanide metal cations and/or d-element metal cations, the comments made above apply to the preferred solubility product SP of such compounds. Preferred cations of such compounds (A1) are optionally organic-radical-substituted ammonium ions, phosphonium ions and/or sulfonium ions, alkali metal cations, such as, in particular, lithium, sodium and/or potassium, alkaline earth metal cations, such as, in particular, magnesium and/or calcium. Particular preference is given to the optionally organic-radical-substituted ammonium ions and the alkali metal cations, which ensure a particularly high solubility product SP on the part of the compound (A1).

Used as component (A2) of the corrosion preventative (K1) is at least one acid capable of oxidation, such that the pH of the corrosion preventative is between 1 and 5, preferably between 2 and 4. Preferred acids (A2) are selected from the group of the oxidizing mineral acids, such as, in particular, nitric acid, nitrous acid, sulfuric acid and/or sulfurous acid.

To set the pH it is possible where necessary to use a buffer medium, such as, for example, ammonia or salts of moderately strong bases and weak acids, such as, in particular, ammonium acetate.

Water is used as a continuous phase for the corrosion preventative (K1), preferably deionized and/or distilled water.

The substrate pretreated as above is contacted with the corrosion preventative (K1). This is accomplished by electroless immersion or drawing of the substrate in or through a bath comprising the corrosion preventative (K1). The residence times of the substrate in the corrosion preventative (K1) are preferably 1 second to 10 minutes, more preferably 10 seconds to 8 minutes, and with particular preference 30 seconds to 6 minutes. The temperature of the bath comprising the corrosion preventative (K1) is preferably between 25 and 90° C., more preferably between 30 and 80° C., with particular preference between 35 and 70° C.

The wet film thickness of the film produced with the coating composition (K1) after autophoretic application is preferably between 5 and 900 nm, more preferably between 15 and 750 nm, and in particular between 25 and 600 nm, as determinable, for example, by visual determination of the interference in the λ/4 region of visible light (opalescence), and also by X-ray fluorescence measurement in accordance with DIN EN ISO 3497.

After the treatment of the substrate with the coating composition (K1) and before the subsequent coating with the corrosion preventative (K2) in stage (II) of the process of the invention, the film of the coating composition (K1) is dried, the drying parameter and drying apparatus being able to be regarded as largely uncritical to the advantageous action of the coating composition of the invention.

Preferably the film of coating composition (K1), before the subsequent coating with the corrosion preventative (K2), is rinsed with distilled water and blown dry with air, preferably with an inert gas, more particularly with nitrogen, preferably at temperatures of up to 50° C.

### The Second Stage (II) of the Process of the Invention

The aqueous corrosion preventative (K2) of the invention which is applied in stage (II) of the process of the invention to the film of the corrosion preventative (K1) comprises preferably water-soluble or water-dispersible polymers (P) which carry ligands (L) which form chelates with the metal ions released on corrosion of the substrate, and which carry functional groups (B) which are able to form covalent bonds with further functional groups (B′) that are part of additional crosslinkers (V).

Water-dispersible or water-soluble in the sense of the invention means that the polymers (P) in the aqueous phase form aggregates having an average particle diameter of <50, preferably <35, and more preferably <20 nanometers (nm) or are in molecularly disperse solution. Water-soluble, i.e. molecularly dispersely dissolved, polymers (P) generally have weight-average molecular weights Mw (determinable by means of gel permeation chromatography in accordance with standards DIN 55672-1 to -3) of <100 000, preferably <50 000, more preferably <20 000 daltons.

The size of the aggregates composed of polymer (P) is brought about in a conventional way by introducing hydrophilic groups (HG) on the polymer (P). The number of hydrophilic groups (HG) on the polymer (P) depends on the solvation capacity and on the steric accessibility of the groups (HG) and may be set by the skilled worker likewise in a conventional manner. Preferred hydrophilic groups (HG) on the polymer (P) are ionic groups such as, more particularly, sulfate, sulfonate, sulfonium, phosphate, phosphonate, phosphonium, ammonium and/or carboxylate groups, and also nonionic groups, such as more particularly hydroxyl groups, primary, secondary and/or tertiary amine groups, amide groups and/or oligoalkoxy or polyalkoxy substituents, such as preferably ethoxylated or propoxylated substituents, which may be etherified with further groups. The hydrophilic groups (HG) may be identical to the ligands (L) described below and/or the crosslinking functional groups (B).

The number of hydrophilic groups (HG) on the polymer (P) is dependent on the solvation capacity and the steric accessibility of the groups (HG) and may be set by the skilled worker likewise in a conventional manner.

In a further embodiment of the invention the abovementioned hydrophilic groups (HG) form a gradient in their concentration along the polymer backbone. The gradient is defined by a gradient in the spatial concentration of the hydrophilic groups along the polymer backbone. Preferred polymers (P) with this kind of construction are described in WO-A-2008/058586. They are capable of forming micelles in the aqueous medium and have a surface activity on the surface of the substrate to be coated; this means that the interfacial energy of the coating composition of the invention at the surface to be coated is reduced.

As the polymer backbone of the polymers (P) it is possible to use any desired polymer constituents, preferably those having weight-average molecular weights Mw (determinable by means of gel permeation chromatography in accordance with the standards DIN 55672-1 to -3) of 1000 to 50 000 daltons, more preferably of 2000 to 20 000 daltons. As polymer backbone it is preferred to use constituents derived from polyolefins or poly(meth)acrylates, polyurethanes, polyvinylamines, polyalkylenimines, polyethers, polyesters, and polyalcohols, which in particular are partly acetalized and/or partly esterified. The polymer backbones may be linear, branched and/or dendritic in construction. Particularly preferred polymer backbones are constituents derived from polyalkylenimines, polyvinylamines, polyalcohols, poly(meth)acrylates, and also from hyperbranched polymers, of the kind described, for example, in WO-A-01/46296; constituents derived from polyalkylenimines are especially preferred.

The polymers (P) are preferably stable to hydrolysis in the acidic pH range, in particular at pH levels <5, more preferably at pH levels <3.

Suitable ligands (L) are all groups or compounds which are able to form chelates with the metal ions released on corrosion of the substrate. Preference is given to unidentate and/or multidentate potentially anionic ligands (L). With particular preference the ligands (L) are introduced by the reaction of functional groups of the polymers (P) with ligand formers (LB) which contain the unidentate and/or multidentate potentially anionic ligands (L); preferably the ligands (L) introduced in this way do not lose their capacity to act as chelate formers when the multicoat paint system is thermally cured.

The ligands (L) are preferably selected from the group consisting of
organophosphorus compounds, such as, in particular, organophosphates and also organophosphonates with organic substituents, preferably phosphonates or phosphates hydroxy-, amino- or amido-functionalized on the organic substituent,
organosulfur compounds, such as, in particular, functionalized thio compounds such as thiol, polythiol, thiocarboxylic acid, thioaldehyde, thioketone, dithiocarbamate, sulfonamide and/or thioamide compounds, preferably polythiols having at least 2 thiol groups, preferably at least 3 thiol groups, more preferably polyester polythiols having at least 3 thiol groups,
acylated ureas and thioureas, such as, in particular, benzoylurea and/or benzoylthiourea compounds,
diamines and/or polyamines, such as, in particular, ethylenediaminetetraacetic acid (EDTA) or, preferably, amines of higher functionality, such as, for example, Jeffcat® products (from Huntsman), such as, in particular, trialkylamines, preferably diaminoalkyl-hydroxyalkylamines, such as, very preferably, N,N-bis(3-dimethylaminopropyl)-N-isopropanolamine (Jeffcat® ZR50),
quinolines, cholines and/or benzimidazoles, such as, in particular, aminoquinoline compounds and/or mercaptobenzimidazole compounds,
hydroxy compounds which have further carbonyl, carboxylic acid, thiocarbonyl and/or imino groups, particularly in a sterically advantageous position, preferably in 1,3-position,
carbonyl compounds which have further carbonyl, carboxylic acid, thiocarbonyl and/or imino groups, in particular in a sterically advantageous position, preferably in 1,3-position, more preferably acetylacetonate compounds,
carbenes and/or
acetylene compounds, such as, in particular, propargyl compounds.

Suitable crosslinking functional groups (B) on the polymer (P) are those which are able to form covalent bonds with themselves and/or preferably, with complementary functional groups (B′) that are sited on the crosslinker (V). The covalent bonds are preferably formed thermally and/or by exposure to radiation. With particular preference the covalent bonds are formed thermally. The crosslinking functional groups (B) and (B′) bring about the formation of an intermolecular network between the molecules of the polymer (P) and of the crosslinker (V).

Functional groups (B) which crosslink on exposure to radiation contain activable bonds, such as, for example, single or double carbon-hydrogen, carbon-carbon, carbon-oxygen, carbon-nitrogen, carbon-phosphorus or carbon-silicon bonds. Carbon-carbon double bonds are particularly advantageous in this context.

Thermally crosslinking functional groups (B) are able, with themselves or, preferably, with complementary crosslinking functional groups (B′), to form covalent bonds on exposure to thermal energy.

Suitable thermally crosslinking functional groups (B) on the polymer (P) are as follows:
with particular preference hydroxyl groups,
with preference amino groups,
mercapto groups,
aldehyde groups,
azide groups,
acid groups, especially carboxylic acid groups,
acid anhydride groups, especially carboxylic anhydride groups,
acid ester groups, especially carboxylic ester groups,
ether groups,
with preference carbamate groups,
urea groups,
with preference epoxide groups,
isocyanate groups, preferably reacted with blocking agents, which at the baking temperatures of the coating compositions of the invention undergo deblocking and/or are incorporated, without deblocking, into the network which forms.

Particularly preferred combinations of thermally crosslinking groups (B) and complementary groups (B′) are as follows:
preferably hydroxyl groups with isocyanate groups,
amino groups with isocyanate and/or carbamate groups,
carboxylic acid groups with epoxide groups.

Suitable crosslinkers V having groups (B′) which crosslink thermally and/or through exposure to radiation are in principle all of the crosslinkers that are known to the skilled worker. Preference is given to low molecular weight or oligomeric crosslinkers (V) having weight-average molecular weights Mw (determinable by means of gel permeation chromatography in accordance with standards DIN 55672-1 to -3) of <20 000 daltons, more preferably <10 000 daltons. The backbone of the crosslinkers (V), which carries the crosslinking groups (B′), may be linear, branched and/or hyperbranched in construction. Branched and/or hyperbranched structures are preferred, more particularly those as described in WO-A-01/46296, for example.

The crosslinkers (V) carry the crosslinking groups (B′) which react with the crosslinking groups of the polymer (P) with the formation of covalent bonds.

Especially suitable crosslinking functional groups (B′) for the crosslinkers (V) are as follows:
hydroxyl groups,
epoxide groups,
preferably carboxylic acid and carboxylic anhydride groups,
carbamate groups, and
more preferably isocyanate groups, which very preferably have been reacted with blocking agents which at the baking temperatures of the coating compositions of the invention undergo deblocking or which are incorporated, without deblocking, into the network which forms,
   or combinations thereof.

In one preferred embodiment of the invention the crosslinkers V, as well as the crosslinking groups (B′), carry ligands (L′) which may be identical to and/or different from the ligands (L) of the polymer (P) and which are able to form chelates with the metal ions released on corrosion of the substrate. Unidentate and/or multidentate potentially anionic ligands (L′) are preferred.

The ligands (L′) are preferably selected from the group of
organophosphorus compounds, such as, in particular, organophosphates and also organophosphonates with organic substituents, preferably phosphonates or phosphates hydroxy-, amino- or amido-functionalized on the organic substituent,
organosulfur compounds, such as, in particular, functionalized thio compounds such as thiol, polythiol, thiocarboxylic acid, thioaldehyde, thioketone, dithiocarbamate, sulfonamide and/or thioamide compounds, preferably polythiols having at least 2 thiol groups, preferably at least 3 thiol groups, more preferably polyester polythiols having at least 3 thiol groups,
acylated ureas and thioureas, such as, in particular, benzoylurea and/or benzoylthiourea compounds,
diamines and/or polyamines, such as, in particular, ethylenediaminetetraacetic acid (EDTA) or, preferably, amines of higher functionality, such as, for example, Jeffcat® products (from Huntsman), such as, in particular, trialkylamines, preferably diaminoalkyl-hydroxyalkylamines, such as, very preferably, N,N-bis(3-dimethylaminopropyl)-N-isopropanolamine (Jeffcat® ZR50),
quinolines, cholines and/or benzimidazoles, such as, in particular, aminoquinoline compounds and/or mercaptobenzimidazole compounds,
hydroxy compounds which have further carbonyl, carboxylic acid, thiocarbonyl and/or imino groups, particularly in a sterically advantageous position, preferably in 1,3-position,
carbonyl compounds which have further carbonyl, carboxylic acid, thiocarbonyl and/or imino groups, in particular in a sterically advantageous position, preferably in 1,3-position, more preferably acetylacetonate compounds,
carbenes and/or
acetylene compounds, such as, in particular, propargyl compounds.

With particular preference the ligands (L′) are introduced into the crosslinker (V) by reaction of the functional groups (B′) of the crosslinker (V) with ligand formers (LB′).

Examples of suitable crosslinkers (V) are amino resins, such as, in particular, melamine resins, guanamine resins and/or urea resins, resins or compounds containing anhydride groups, such as polysuccinic anhydride, for example, resins or compounds containing epoxy groups, such as, in particular, aliphatic and/or cycloaliphatic polyepoxides, tris(alkoxycarbonylamino)triazines, such as, in particular, those described in U.S. Pat. No. 4,939,213, U.S. Pat. No. 5,084,541 or EP-A-0 624 577, resins or compounds containing carbonate groups, beta-hydroxyalkylamides, and, in the preferred embodiment of the invention, polyisocyanates, which preferably are blocked.

If the water solubility or water dispersibility is still not sufficient, the crosslinker (V) may be modified hydrophilically in a known way. Water-dispersible in the sense of the invention means that the crosslinker (V), at up to a certain concentration in the aqueous phase, forms stable aggregates having an average particle diameter of <500, preferably <100 nm, and more preferably <50 nanometers. For this purpose, in particular, ionic and/or nonionic substituents are introduced into the crosslinker (V). More particularly these are, in the case of anionic substituents, phenoxide, carboxylate, sulfonate and/or sulfate groups; in the case of cationic substituents, ammonium, sulfonium and/or phosphonium groups; and, in the case of nonionic groups, oligoalkoxylated or polyalkoxylated, more preferably ethoxylated, substituents.

With particular preference the crosslinker (V) comprises at least one di- and/or polyisocyanate in which some of the isocyanate groups have been reacted with blocking agents which are eliminated when the multicoat paint system is thermally cured, and in which the remainder of the isocyanate groups have been reacted with the above-described ligand formers (LB′) which serve for introducing the unidentate and/or multidentate potentially anionic ligands (L′) into the crosslinker (V), the ligands (L′) introduced in this way preferably not losing their capacity to act as chelate formers when the multicoat paint system is thermally cured.

Examples of polyisocyanates preferred as crosslinkers (V) are polyisocyanates containing isocyanurate, biuret, allophanate, iminooxadiazinedione, urethane, urea and/or uretdione groups. Preference is given to using aliphatic or cycloaliphatic polyisocyanates, especially hexamethylene diisocyanate, dimerized or trimerized hexamethylene diisocyanate, isophorone diisocyanate, dicyclohexylmethane 2,4′-diisocyanate, dicyclohexylmethane 4,4′-diisocyanate, diisocyanates derived from dimer fatty acids, or mixtures of the aforementioned polyisocyanates.

Very particular preference is given to using polyisocyanates containing uretdione groups and/or isocyanurate groups and/or allophanate groups, especially those based on trimers, tetramers, pentamers and/or hexamers of diisocyanates, more preferably of hexamethylene diisocyanate, as crosslinkers (V).

As blocking agents for the preferred isocyanate groups (B′) of the crosslinker (V) it is preferred to use the compounds that are described in DE 199 48 004 A1 at page 15 lines 5 to 36. Particularly preferred blocking agents are dimethylpyrazole and/or malonic ester.

Especially preferred as crosslinkers (V) are polyisocyanates which contain uretdione groups and/or isocyanurate groups and/or allophanate groups, based on hexamethylene diisocyanate, in which 10 to 90 mol %, preferably 25 to 75 mol %, and more particularly 35 to 65 mol %, based on the total number of free isocyanate groups, of the isocyanate groups are blocked, in particular with dimethylpyrazole and/or malonic ester, and in which 10 to 90 mol %, preferably 25 to 75 mol %, and more particularly 35 to 65 mol %, based on the total number of free isocyanate groups, are reacted with the above-recited preferred ligand formers (LB′), more preferably ligand formers (LB′) selected from the group of diamines and polyamines, such as, in particular, EDTA or Jeffcat products, such as, preferably, trialkylamines, more preferably diaminoalkyl-hydroxyalkylamines, such as, very preferably, Jeffcat® ZR50, aminoquinolines and/or benzimidazoles, polythiols having at least 2 thiol groups, preferably at least 3 thiol groups, such as, very preferably, polyesterthiols having at least 3 thiol groups, and/or functionalized acetylenes, such as, very preferably, propargyl alcohol, and mixtures of such ligand formers (LB′).

In a further preferred embodiment of the invention the corrosion preventative (K2) comprises mixtures of at least two different crosslinkers (V1) and (V2), selected from the group of the above-described crosslinkers (V) with ligands (L′).

The continuous phase used for the corrosion preventative (K2) is water, preferably deionized and/or distilled water. As a further component it is preferred to use at least one acid which is capable of oxidation, in amounts such that the pH of the corrosion preventative (K2) is between 2 and 7, preferably between 3 and 6. Particularly preferred acids are selected from the group of the oxidizing mineral acids, such as, in particular, nitric acid, nitrous acid, sulfuric acid and/or sulfurous acid. To set the pH it is possible where necessary to use a buffer medium, such as salts of moderately strong bases and weak acids, for example, such as ammonium acetate in particular.

Preferably the corrosion preventative (K2) comprises the polymer (P) in fractions of 0.1 to 100, more preferably of 0.2 to 50, and very preferably of 0.5 to 20 g per liter of corrosion preventative (K2), and comprises the crosslinker (V) in fractions of 0.05 to 50, more preferably of 0.1 to 30, and very preferably of 0.2 to 15 g per liter of corrosion preventative (K2).

In a further embodiment of the invention the corrosion preventative (K2) comprises at least one component which reduces the surface tension of the corrosion preventative of the invention on autophoretic deposition on the substrate surface and/or in the subsequent drying step. Preferred such corrosion preventatives with components which reduce the surface tension of the corrosion preventative are described in WO-A-2008/058587.

In one further embodiment of the invention the corrosion preventative (K2) further comprises a salt (S) which contains lanthanide metal cations and/or d-metal cations as its cationic constituent.

Preferred lanthanide metal cations are lanthanum, cerium, praseodymium, neodymium, promethium, samarium, europium and/or dysprosium cations. Particular preference is given to lanthanum, cerium, and praseodymium cations. The lanthanide metal cations may be present in a monovalent, divalent and/or trivalent oxidation state, the trivalent oxidation state being preferred. Preferred d-element metal cations are titanium, vanadium, manganese, yttrium, zirconium, niobium, molybdenum, tungsten, cobalt, ruthenium, rhodium, palladium, osmium and/or iridium cations. Excepted as a d-element cation is the chromium cation in all oxidation states. Particular preference is given to vanadium, manganese, tungsten, molybdenum and/or yttrium cations. The d-element cations may be present in a monovalent to hexavalent oxidation state, preference being given to a trivalent to hexavalent oxidation state. The lanthanide metal cations and/or d-element cations of the salt (S) may also take the form of complexes with the aforementioned unidentate and/or multidentate potentially anionic ligands (L1).

In step (II) of the process of the invention, the substrates coated with the corrosion preventative (K1) are coated with the coating composition (K2). In this case the substrate coated with the corrosion preventative (K1) is left to evaporate, or dried, before the corrosion preventative (K2) as described above is applied.

Coating takes place preferably by immersing or drawing the coated substrate in or through a bath containing the corrosion preventative (K2). The residence times of the substrate in the corrosion preventative (K2) are preferably 1 second to 15 minutes, more preferably 10 seconds to 10 minutes, and very preferably 30 seconds to 8 minutes. The temperature of the bath containing the corrosion preventative (K2) of the invention is preferably between 20 and 90° C., more preferably between 25 and 80° C., very preferably between 30 and 70° C.

The wet film thickness of the film produced with the coating composition (K2) after autophoretic application is preferably between 5 and 1500 nm, more preferably between 15 and 1250, in particular between 25 and 1000 nm, determinable for example by visual determination of the interference in the λ/4 region of visible light (opalescence) and also by X-ray fluorescence measurement in accordance with DIN EN ISO 3497.

After the substrate has been treated with the corrosion preventative (K2) and before the subsequent coating with the coating composition (F) in stage (III) of the process of the invention, drying of the assembly formed from the substrate and the films of the corrosion preventative (K1) and also the corrosion preventative (K2) is carried out at temperatures between about 30 and 200° C., in particular between 100 and 180° C., the drying apparatus being able to be regarded as largely uncritical to the advantageous action of the corrosion preventative (K2) of the invention. Preferably the assembly formed from corrosion preventative (K1) and corrosion preventative (K2) is rinsed with distilled water and blown dry with air, preferably with an inert gas, more particularly with nitrogen, preferably at temperatures of up to 50° C., and left to evaporate before the subsequent stage (III) of the process of the invention—that is, exposed for a period of 30 seconds to 30 minutes, preferably for a period of 1 minute to 25 minutes, to temperatures of between 25 and 120° C., preferably between 30 and 90° C.

### Stages (III) and (IV) of the Coating Process of the Invention

In the third stage (III) of the process of the invention, a coating composition (F) is applied to the assembly of coating composition (K1) and coating composition (K2) produced in accordance with stage (II), the coating composition (F) comprising at least one binder (FB) having the above-described functional groups (B) and/or (B′).

In the preferred embodiment of the invention the coating composition (F) is an aqueous coating composition, more particularly an aqueous primer-surfacer, of the kind used, for example, in automotive OEM finishing.

Aqueous primer-surfacers (F) of this kind are described in EP 0 269 828 B1, for example, the water-dispersible hydroxyl-containing polyesters described therein being preferred as a component of the binders (FB) of the invention. More particularly the water-dispersible hydroxyl-containing polyesters described in EP 0 269 828 B1 at page 2 line 34 to page 4 line 16 or in WO 01/02457 A1 at page 24 line 2 to page 28 line 19, are used as binder component (FB1), such polyesters preferably having an acid number to DIN EN ISO 3682 of 20 to 150, preferably 30 to 120, mg KOH/g nonvolatile fraction and a hydroxyl number to DIN EN ISO 4629 of 50 to 300, preferably 80 to 250, mg KOH/g nonvolatile fraction.

As a further binder component (FB2) in the aqueous primer-surfacer (F), one preferred embodiment of the invention uses water-dispersible hydroxyl-containing polyesterpolyurethanes of the kind described in DE 44 38 504 A1 and WO 01/02457 A1, for example. Such polyesterpolyurethanes preferably have an acid number to DIN EN ISO 3682 of 0 to 50, preferably 5 to 30, mg KOH/g nonvolatile fraction and a hydroxyl number to DIN EN ISO 4629 of 20 to 200, preferably 30 to 150, mg KOH/g nonvolatile fraction.

The binder components (FB) are present in the primer-surfacer (F) in amounts of 1% to 70%, preferably 2% to 60%, and more preferably 5% to 50% by weight, based on the solids content of the primer-surfacer (F). As further components the primer-surfacer (F) preferably comprises crosslinkers (FV), particularly preferred crosslinker components employed being amino resins (FV1) and/or capped polyisocyanates (FV2). One especially preferred embodiment of the invention employs mixtures of water-dilutable amino resins (FV1), more particularly melamine-formaldehyde resins, of the kind described in WO 01/02457 A1, for example, at page 23 lines 8 to 25, and of water-dilutable capped polyisocyanates (FV2), of the kind described in DE 199 48 004, for example, at page 15 lines 4 to 62.

The crosslinkers (FV) are present in the primer-surfacer (F) in amounts of 1% to 50%, preferably 2% to 40%, and more preferably 3% to 30% by weight, based on the solids content of the primer-surfacer (F).

Further typical constituents of the primer-surfacer (F) that are used are, in particular, suitable organic and/or inorganic fillers and/or pigments, of the kind described in WO 01/02457 A1, for example, at page 29 line 1 to page 30 line 3. Particular preference is given to using fillers such as carbon black, titanium dioxide, and talc. The pigments and/or fillers are present in the primer-surfacer (F) in amounts of 10% to 80%, preferably 15% to 70%, and more preferably 20% to 65% by weight, based on the solids content of the primer-surfacer (F).

Moreover, the primer-surfacers (F) contain, in amounts of up to 40%, preferably of up to 30%, more preferably of up to 20%, by weight, based on the primer-surfacer (F), further additives, as described in WO 01/02457 at page 30 line 8 to page 32 line 17.

The coating composition (F) is applied preferably by spray application, more particularly by pneumatic application. The coating composition (F) is applied in a wet film thickness such that curing of the film of coating composition (F) results in a dry film thickness of 5 to 60 μm, preferably 10 to 50 μm, and more particularly from 15 to 40 μm.

The coat systems produced in the sequence of stages (I) and (III) or of stages (I), (II), and (III) of the coating process of the invention are, in one preferred embodiment of the invention, allowed to evaporate, preferably for a period of 30 seconds to 30 minutes, at temperatures between 20 and 100° C., preferably between room temperature and 80° C., and thereafter are baked at temperatures of 100 to 200° C., preferably at temperatures of 120 to 180° C., for a time of 10 to 60 minutes, preferably for a time of 15 to 30 minutes.

Surprisingly the coating of coating composition (F) that is applied in stage (III) adheres outstandingly to the coat deposited in stage (I) and stage (II). The coat systems also exhibit outstanding resistance to impact stress.

In stage (IV) of the process of the invention, further films that are customary in automotive OEM finishing are applied by conventional methods over the coat applied in stage (III), preferably in the order of basecoat and clearcoat; in the case of the basecoat material, application takes place in particular by means of electrostatic spray application (ESTA) and, in the case of the clearcoat material, preferably by spray application. The basecoat material employed with preference is applied in a wet film thickness such that curing of the film of basecoat material results in a dry film thickness of 5 to 40 μm, preferably 8 to 35 μm, and more particularly from 10 to 30 μm. The clearcoat material employed with preference is applied in a wet film thickness such that curing of the film of clearcoat material results in a dry film thickness of 10 to 70 μm, preferably 15 to 65 μm, and more particularly from 20 to 60 μm. In one particularly preferred embodiment of the invention, application of the basecoat material is followed, and application of the clearcoat material preceded, by evaporation at temperatures of 15 to 40° C. for 1 to 20 minutes, followed by drying at temperatures of 40 to 100° C. After the application of the clearcoat material it is preferred to carry out evaporation at temperatures of 15 to 40° C. for 1 to 20 minutes and then to carry out baking at temperatures of 100 to 200° C., preferably at temperatures of 120 to 180° C., for a time of 10 to 60 minutes, preferably for a time of 15 to 30 minutes.

The process of the invention can be employed surprisingly on a wide spectrum of substrates and is largely independent of the redox potential of the substrate.

Preferred substrate materials are zinc, iron, magnesium, and aluminum, and also their alloys, the aforementioned metals being present in the alloys at—preferably—at least 20% by weight. The substrates are preferably formed as metal panels of the kind employed, for example, in the automobile industry, the construction industry, and the machine-building industry.

The corrosion resistance of the coat system applied in stages (I) to (IV) of the process of the invention is excellent and meets to a high degree the requirements of automobile construction.

The examples given below are intended further to illustrate the invention.

### EXAMPLES

### Preparation Example 1

### Preparation of the First Pretreatment Tank with the Corrosion Preventative K1

1.77 g (0.01 mol) of ammonium molybdate tetrahydrate (A1) were dissolved in one liter of water. The solution was adjusted using nitric acid (A2) to a pH of 2.5. Where appropriate, counter-buffering took place with aqueous ammonia solution for the purpose of setting the aforementioned pH.

### Preparation Example 2

### Synthesis of the Polymer Component P for the Corrosion Preventative K2

5 g (6.25*10⁻³ mol) of a polyethylenimine having an average molecular weight Mw=800 g/mol (Lupasol FG from BASF SE, ratio of primary:secondary:tertiary amino groups (p-s-t):1:0.9:0.5) were introduced in 100 g of ethanol under a nitrogen atmosphere and at 75° C., over the course of 45 minutes, 10.7 g (0.066 mol) of benzoyl isothiocyanate in solution in 86 g of ethanol were added. The mixture was stirred at this temperature for 4 h more and the product was used without further purification.

### Preparation Example 3a

### Synthesis of the Crosslinker V1 for the Corrosion Preventative K2

17.16 g (0.07 mol) of N,N-bis(3-dimethylaminopropyl)-N-isopropanolamine (Jeffcat ZR® 50 from Huntsman) as ligand former (LB) were reacted together with 50 g (5.81% NCO content) of an 81% strength butyl acetate solution of a branched polyisocyanate which was based on hexamethylene 1,6-diisocyanate and was blocked to an extent of 50 mol % with dimethylpyrazole (Bayhydur 304 from Bayer AG) at 80° C. for four hours. This gave a solution which was used without further purification.

### Preparation Example 3b

### Synthesis of the Crosslinker V2 for the Corrosion Preventative K2

8.54 g (0.035 mol) of mercaptobenzimidazole (Merck, Darmstadt) as ligand former (LB1) were reacted together with 50 g (5.81% NCO content) of an 81% strength butyl acetate solution of a branched polyisocyanate which was based on hexamethylene 1,6-diisocyanate and was blocked to an extent of 50 mol % with dimethylpyrazole (Bayhydur 304 from Bayer AG) at 80° C. for two hours. Subsequently 8.58 g (0.035 mol) of N,N-bis(3-dimethylaminopropyl)-N-isopropanolamine (Jeffcat ZR® 50 from Huntsman) were added as ligand former (LB2) and reaction was carried out at 80° C. again for two hours. This gave a solution which was used without further purification.

### Preparation Example 4

### Preparation of the Second Pretreatment Tank with the Corrosion Preventative K2

3 g of the polymer component P of preparation example 2, 1 g of the crosslinker V1 of preparation example 3a, and 1 g of the crosslinker V2 of preparation example 3b were dissolved in one liter of water. The solution was adjusted using nitric acid to a pH of 5.0. Where appropriate, counter-buffering took place with aqueous ammonia solution for the purpose of setting the aforementioned pH.

### Example 1

### Coating of the Substrate with the Corrosion Preventative K1 (Stage I of the Inventive Process) and with the Corrosion Preventative K2 (Stage II of the Inventive Process)

The substrate (panel of galvanized steel) was cleaned in a cleaning solution (Ridoline C72 from Henkel) at 55° C. for 5 minutes and then rinsed with distilled water.

Subsequently the panel rinsed with distilled water was immediately immersed into the first tank of the corrosion preventative K1 from preparation example 1 at 45° C. for 4 minutes. An invisible to opalescent film was formed with interferrences in the λ/4 region of visible light. Thereafter the coated panel was rinsed with distilled water and blown dry with nitrogen.

Directly after that the panel thus coated was immersed for 5 minutes at 35° C. into the second tank of the inventive corrosion preventative K2 from preparation example 4. A second invisible to opalescent film was formed, with interferences in the λ/4 region of visible light. Thereafter the panel with its two-stage coating was rinsed with distilled water, blown dry with nitrogen, and evaporated at 80° C. for 2.5 minutes.

### Example 2

### Coating of the Panel Coated as Per Example 1 in Accordance with Stages (III) and (IV) of the Inventive Process

The panel coated as per example 1 and conditioned was coated in stage (III) of the inventive process with an aqueous primer-surfacer (F) comprising—in addition to further constituents typical of primer-surfacers, as described in example 3 of EP-B1-0 726 919 —as binder components (FB) a combination of 21% by weight, based on the primer-surfacer (F), of an aqueous dispersion of an epoxide-modified polyester (FB1), as described in EP-B1-0 269 828, the monomer constituents being selected such that there is a hydroxyl number to DIN EN ISO 4629 of 185 mg KOH/g nonvolatile fraction and an acid number to DIN EN ISO 3682 of 45 KOH/g nonvolatile fraction, and a fraction of nonvolatile constituents of 35% by weight (FB1) being set in the dispersion, and, as a further binder, 21% by weight, based on the primer-surfacer (F), of an aqueous dispersion of a hydroxyl-containing polyester polyurethane (FB2=BAYHYDROL PT 241 from Bayer AG) with a hydroxyl number to DIN EN ISO 4629 of approximately 85 mg KOH/g nonvolatile fraction and an acid number to DIN EN ISO 3682 of approximately 7.5 KOH/g nonvolatile fraction, and a fraction of nonvolatile constituents of 41% by weight (FB1) being set in the dispersion, and also, as crosslinker components (FV), 5% by weight, based on the primer-surfacer (F), of a mixture of water-dilutable methanol-etherified melamine resins (FV1=50/50 mixture of Cymel 327 and Cymel 1130 from CYTEC) and also 5% by weight, based on the primer-surfacer (F), of a water-dilutable capped polyisocyanate (FV2) based on an isocyanurate adduct of hexamethylene diisocyanate, with a calculated capped isocyanate group content of 7.5% to 8% by weight, based on the polyisocyanate (FV2), by means of pneumatic application, in a wet film thickness such as to result in a dry film thickness of 25 to 30 μm. Thereafter the panel coated with the primer-surfacer was left to evaporate at room temperature for 10 minutes and then baked at a panel temperature of 165° C. for 20 minutes.

Subsequently, in stage (IV) of the inventive process, a commercial basecoat material (Color Pro 1 from BASF Coatings AG) was applied in a wet film thickness such as to result in a dry film thickness of 15 μm. Thereafter the panel coated with the basecoat material was left to evaporate at room temperature for 4 minutes and then dried at a panel temperature of 80° C. for 10 minutes.

Finally, a commercial clearcoat material (Pro Gloss from BASF Coatings AG) was applied in a wet film thickness such as to result in a dry film thickness of 30 to 35 μm. Thereafter the panel coated with the basecoat material and with the clearcoat material was left to evaporate at room temperature for 10 minutes and then baked at a panel temperature of 135° C. for 20 minutes.

### Comparative Example 2

For comparative example 2a panel of galvanized steel coated with a commercial phosphating agent (Gardobond 26S W42 MBZE3 from Chemetall) was coated with a commercial lead-free cathodic electrocoat material (Cathoguard® 500 from BASF Coatings AG) at a bath temperature of 32° C. in a deposition time of 120 seconds and was subsequently cured at 175° C. for 20 minutes. The thickness of the deposited and cured coat of cathodic electrocoat material was 19 to 20 μm. Subsequently the system made up of primer-surfacer, in accordance with stage (III) of the process described above, and also of basecoat material and clearcoat material, in accordance with stage (IV) of the process described above, was applied, dried, and cured.

### Example 3

### Climatic Cycling Test on the Panels Coated in Example 2 and in Comparative Example 2

After the coated panels had been scored with a scribe mark going down to the metal substrate, the panels were subjected to a KWT climatic cycling test in accordance with VDA test sheet 621-415 (February 1982), the samples going through 10 weekly cycles, with 1 weekly cycle being structured as follows:

### Monday:

Salt spray mist testing to DIN ISO 9227

### Tuesday to Friday:

Constant climate at 40° C. to DIN ISO 6270-2KK

### Saturday and Sunday:

Regeneration at 23° C. and 50% relative humidity

As a measure of the corrosion, the corrosive undermining (creep) at the scribe mark was determined using a micrometer screw.

Table 1 compiles the results. It is seen that the corrosion resistance of the inventive coat system, in comparison to a coat system consisting of a phosphate coat, which itself requires a plurality of pretreatment tanks, of a cathodic deposition coat, and of a system in accordance with stages (III) and (IV) of the inventive process, is comparable, and hence it is possible to do entirely without a cathodic deposition coat.

TABLE 1
Results of the climatic cycling tests (KWT)

| Substrate | | |
|---|---|---|
| (galvanized | | KWT: undermining at |
| steel panel) | Pretreatment | the scribe mark (mm) |
| Example 2 | Inventive pretreatment | 2.3 |
| Comparative | Phosphating and subsequent | 2.4 |
| Example 2 | cathodic deposition coating | |

1. A multistage process for coating metallic substrates, comprising:
(I) applying to a substrate in a first stage, an electroless deposition coating comprising an aqueous corrosion preventative (K1), the preventative (K1) comprising
at least one compound (A1) comprising a member selected from the group consisting of a lanthanide metal cation, a d-element metal cation, a d-element metallate as anion, and combinations comprising two or more of the foregoing, and
at least one acid (A2) capable of oxidation,
(II) applying to the substrate in a second stage, a further electroless deposition coating comprising an aqueous corrosion preventative (K2), the preventative (K2) comprising
(1) at least one water-dispersible and/or water-soluble polymer (P) comprising functional groups (B) and covalently bonded ligands (L) which form chelates with one or more of (i) the metal ions released on corrosion of the substrate, and (ii) the substrate surface, and
(2) at least one water-dispersible and/or water-soluble crosslinker (V) comprising functional groups (B′) which react with the functional groups (B) of the polymer (P), and covalently bonded ligands (L′) which form chelates with one or more of (i) the metal ions released on corrosion of the substrate, and (ii) the substrate surface,
(III) applying to the substrate in a third stage, a coating composition (F) comprising at least one binder (FB) comprising one or more functional groups selected from the group consisting of the above-described functional groups (B), the above described functional groups (B′), and combinations comprising two or more of the foregoing, and also
(IV) applying to the substrate in a concluding stage, a topcoat composed of a first basecoat and a concluding clearcoat.

2. The process of claim 1, wherein at least one component of the compound (A1) of the corrosion preventative (K1) used in stage (I) of the process is a d-element metallate selected from the group consisting of tungstate, permanganate, vanadate, molybdate, and combinations comprising two or more of the foregoing.

3. The process of claim 1, wherein one or more of the ligands (L) of the polymer (P) of the corrosion preventative (K2) used in stage (II) of the process, and the ligands (L′) of the crosslinker (V) of the corrosion preventative (K2) used in stage (II) of the process, are selected from the following group:
organophosphorus compounds;
organosulfur compounds;
acylated ureas and thioureas;
diamines, polyamines, or combinations thereof;
quinolines, cholines, benzimidazoles, or combinations thereof;
hydroxy compounds which have further carbonyl, carboxylic acid, thiocarbonyl and/or imino groups;
carbonyl compounds which have further carbonyl, carboxylic acid, thiocarbonyl and/or imino groups in 1,3-position;
carbenes;
acetylene compounds;
and combinations of two or more of the foregoing.

4. The process of claim 1, wherein the polymer (P) of the corrosion preventative (K2) used in stage (II) of the process has a polymer backbone comprising one or more units selected from the group consisting of polyesters, polyacrylates, polyurethanes, polyolefins, polyalcohols, polyvinyl ethers, polyvinylamines, and, polyalkylenimine.

5. The process of claim 1, wherein the functional groups (B) of the polymer (P) of the corrosion preventative (K2) used in stage (II) of the process are selected from the group consisting of amino, carbamate, epoxide, and hydroxyl groups.

6. The process of claim 1, wherein the crosslinker (V) of the corrosion preventative (K2) used in stage (II) of the process comprises at least one di- and/or polyisocyanate comprising isocyanate groups which have been reacted with a blocking agent.

7. The process of claim 1, wherein the coating composition (F) used in stage (III) is an aqueous primer-surfacer comprising a water-dispersible hydroxyl-containing polyester as binder constituent (FB1).

8. The process of claim 1, wherein the coating composition (F) used in stage (III) comprises a water-dispersible hydroxyl-containing polyester polyurethane as binder constituent (FB2).

9. The process of claim 1, wherein the coating composition (F) used in stage (III) comprises at least one crosslinker (FV) selected from the group consisting of amino resins, capped polyisocyanates, and combinations comprising the foregoing.

10. The process of claim 1, wherein the substrate on the surface to be coated comprises at least 20% by weight of a metal which is selected from the group consisting of Fe, Al, Zn, and combinations thereof.

11. The process of claim 3, wherein one or more of the ligands (L) and the ligands (L′) are selected from the group consisting of
organophosphorus compounds, organophosphates with organic substituents, or organophosphonates with organic substituents, wherein the organic substituents comprise functional groups selected from the group consisting of hydroxy-, amino- or amido-;
organosulfur compounds selected from the group consisting of functionalized thio compounds such as thiol, polythiol, thiocarboxylic acid, thioaldehyde, thioketone, dithiocarbamate, sulfonamide, thioamide compounds, polythiols having at least 2 thiol groups, polythiols having at least 3 thiol groups, polyester polythiols having at least 3 thiol groups, and combinations thereof;
acylated ureas, thioureas, benzoylurea, benzoylthiourea compounds, and combinations thereof;
diamines, polyamines, ethylenediaminetetraacetic acid (EDTA), trialkylamines, diaminoalkyl-hydroxyalkylamines, N,N-bis(3-dimethylaminopropyl)-N-isopropanolamine, and combinations thereof;
quinolines, cholines, benzimidazoles, aminoquinoline compounds, mercaptobenzimidazole compounds, and combinations thereof;
hydroxy compounds which have further carbonyl, carboxylic acid, thiocarbonyl and/or imino groups, in a 1,3-position;
carbonyl compounds which have further carbonyl, carboxylic acid, thiocarbonyl and/or imino groups in 1,3-position and acetylacetonate compounds;
carbenes;
acetylene compounds, and propargyl compounds; and
combinations comprising two or more of the foregoing.
